(19) United States
(12) Patent Application Publication
(10) Pub. No.: US 2003/0197749 A1
(43) Pub. Date: Oct. 23, 2003

(54) Image processing method, and output image

(75) Inventor: Shigeki Kawakami, Kanagawa (JP)

Correspondence Address: SUGHRUE MION, PLLC, 2100 PENNSYLVANIA AVENUE, N.W., WASHINGTON, DC, 20037, US

(73) Assignee: FUJI PHOTO FILM CO., LTD.

(21) Appl. No.: 10/391,587

(22) Filed: Mar. 20, 2003

(30) Foreign Application Priority Data
Apr. 18, 2002 (JP) 2002-116165

(51) Int. Cl. B41J 2/205; G06K 1/00

(52) U.S. Cl. 347/15; 358/1.9

(57) ABSTRACT

In an image processing method, for object drawing areas 210 and 220 on a printing sheet 200 and a paper color area 230 in which a paper color for the printing sheet is simulated, mutually different drawing ways (dot types and the number of lines of dots) are designated, so that a data conversion is performed in accordance with the designated drawing ways for the object drawing areas 210 and 220 and the paper color area 230 to create output image data.

### BACKGROUND OF THE INVENTION

1. Field of the Invention

The present invention relates to an image processing method of converting page description data, which is described by page description language, into output image data, and an output image outputted via a data conversion according to the image processing method as mentioned above.

2. Description of the Related Art

Hitherto, when an image printing is performed using a printing machine, there is performed such a matter that prior to performing a printing, a printer and the like is used to create a proof image similar to a printed image obtained through printing of the printing machine, and it is examined whether a desired printed matter can be obtained. The printer for creating such a proof image is referred to as a proofer.

Here, when an image printing is performed using a printing machine, there are used various types of paper in accordance with the object, for example, a news paper, a wood free paper, and a gloss paper. To the contrary, in a proofer, it is difficult to always prepare the same type of paper as the paper used in printing so as to print out a proof image on the paper, and it is greatly restricted in type of paper.

For this reason, when a proofer outputs a proof image, it may happen that there is a need to simulate a color of a paper of a sheet to be used in printing. And thus a color conversion including a simulation of a color for printing is performed so that it is performed to output a proof image similar in a paper color too.

However, in case of the usual proof image, it cannot be distinguished whether a color expressed on a proofer is dependent on a paper color or a fact of drawing an object actually intended on the paper, and thus there is a problem that the usual proof image is not a proof image similar with great accuracy.

For example, in case of a proofer adopting a system of expressing gradation with density (a system of outputting an image on a photographic paper, for instance), a paper color is reproducible, but with respect to an object drawing area, it is not concerned with halftone dots. And thus, according to the proofer adopting the system of expressing gradation with density it is impossible to express the feel of a material; of finish and troubles peculiar to the halftone dot, such as moire, and seam.

Further, in case of a proofer according to a system of expressing gradation with halftone dots, it is possible to simulate an object drawing area with great accuracy. However, a paper color to be expressed with essentially even density but not halftone dots is expressed by halftone dots visually recognizable in a similar fashion to that of the object drawing area. Thus, this involves such a problem that the feel of a material of paper is not expressed. Further, there is a possibility that this causes such a misunderstanding that “ink is put but not a paper color”.

### SUMMARY OF THE INVENTION

In view of the foregoing, it is an object of the present invention to provide an image processing method of implementing an expression avoiding the confusion of a paper color with an object to be drawn, and an output image expressed free from the confusion of the paper color with the object.

To achieve the above-mentioned object, the present invention provides an image processing method of converting page data in which one or a plurality of objects is described in a page description language into output image data representative of an output image, said image processing method comprising steps of:

designating a drawing way for a first area on which an object is drawn, on a drawing area on which an output image is drawn, and a drawing way for a second area excepting the first area, on the drawing area, the drawing way for the first area being different from the drawing way for the second area; and

creating output image data drawn in accordance with the mutually different drawing ways in which the first area and the second area are designated, respectively.

Hitherto, according to a system in which a halftone dot proofer is used to express a portion of paper color too with halftone dots, a proof image is created in accordance with the same halftone dot system with respect to the paper color area and the object drawing area in which an object is drawn. In this case, as mentioned above, it is difficult to discriminate between the portion of paper color and the object drawing area. This causes confusion.

To the contrary, according to the image processing method of the present invention, for the object drawing area (the first area) and the paper color area (the second area), mutually different drawing ways are designated, so that a data conversion is per formed in accordance with the designated drawing ways for the object drawing area and the paper color area to create output image data. Thus, it is possible to obtain the output image avoiding the confusion of the object drawing area (the first area) and the paper color area (the second area) in accordance with the output image data.

In the image processing method according to the present invention as mentioned above, it is preferable that as the drawing way for the first area and the drawing way for the second area, drawing ways using halftone dots of mutually different dot types are designated.

This feature makes it possible to obtain the output image avoiding the confusion of the object drawing area (the first area) and the paper color area (the second area) in accordance with the output image data.

Further, in the image processing method according to the present invention as mentioned above, it is also preferable that as the drawing way for the first area and the drawing way for the second area, drawing ways using halftone dots of mutually different number of lines are designated.

The use of the halftone dots of mutually different number of lines also makes it possible to obtain the output image avoiding the confusion of the object drawing area (the first area) and the paper color area (the second area) in accordance with the output image data. Particularly, in the event that the paper color area (the second area) is expressed with the number of lines (for example, 300 lpi (line per inch) more than the object drawing area (the first area), wherein the object drawing area is expressed with halftone dots, for example, 120 lpi, it is difficult to visually recognize halftone dots of the paper color area (the second area). And thus, it is possible to obtain the feel of a material similar to a case where the paper color is expressed with the original even density.

Incidentally, varying the dot type between the first area and the second area is not contrary to varying the number of lines of dots. And thus it is acceptable that they are simultaneously adopted.

In the image processing method according to the present invention as mentioned above, it is preferable that as the drawing way for the first area, a drawing way using halftone dots is designated, and as the drawing way for the second area, a drawing way in which gradation is expressed by density is designated.

In this case, when the output image is obtained in accordance with the obtained output image data, there is a need to provide a proofer capable of expressing gradation with both the halftone dot and the density. When such a proofer can be prepared, it is possible to obtain an output image in which as to the object drawing area (the first area), gradation is expressed with halftone dots, and as to the paper color area (the second area), the paper color is expressed with original even density of the paper color.

Incidentally, an aspect of the image processing method of the present invention resides in the point how output image data is determined. It is acceptable that the output image, which is outputted in accordance with the determined output image data, is printed out on the actual sheet, or alternatively, it is acceptable that the output image is displayed on a display screen of a display unit. With respect to the way of the utilization of the output image data, it is not restricted to the way of specified one.

To achieve the above-mentioned object, the present invention provides an output image including one or a plurality of objects outputted on a sheet, wherein a first area in which the object is drawn and a second area expressing a color of a background, excepting the first area, are drawn by mutually different drawing ways.

In the output image of the present invention, the first area (the object drawing area) and the second area (paper color area) are drawn by mutually different drawing ways. This feature makes it possible to avoid the confusion between the first area and the second area.

### BRIEF DESCRIPTION OF THE DRAWINGS

FIG. 1 is a schematic constitution view of a printing proof system.

FIG. 2 is a perspective view of a personal computer and a printer shown in FIG. 1.

FIG. 3 is a hardware structural view of the personal computer shown in FIG. 1.

FIG. 4 is a functional block diagram of an image processing apparatus constructed in the personal computer shown in FIG. 1.

FIG. 5 is a view showing an example of an output image.

FIG. 6(A) and FIG. 6(B) are views showing enlarged internal images of circle A and circle B of the output image shown in FIG. 5, respectively.

FIG. 7 is a flowchart useful for understanding an embodiment of an image processing method according to the present invention.

FIG. 8(A) and FIG. 8(B) are views showing partially enlarged portions of the output image according to another embodiment.

### DETAILED DESCRIPTION OF PREFERRED EMBODIMENTS

Embodiments of the present invention will be described with reference to the accompanying drawings.

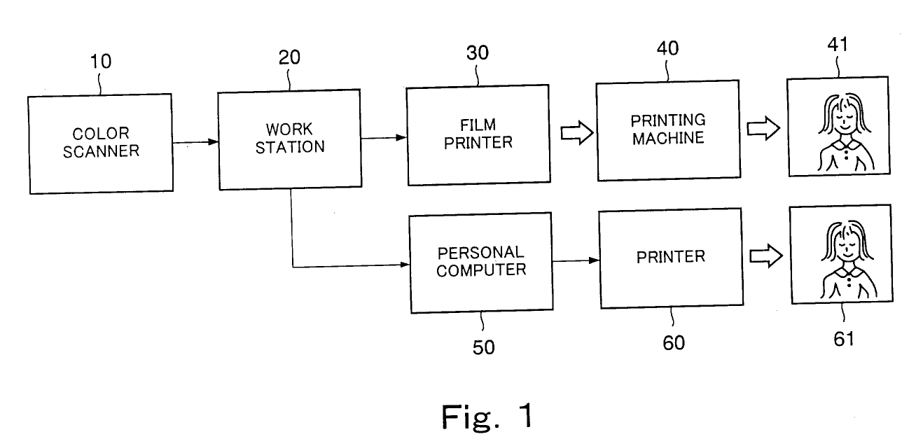

FIG. 1 is a schematic constitution view of a printing proof system into which an image processing apparatus for implementing an image processing method according to an embodiment of the present invention is incorporated.

A color scanner 10 reads an original image and creates image data for four colors consisting of cyan (C) magenta (M), yellow (Y) and black (K), which represent the original image thus read. The image data of CMYK produced by the scanner 10 is fed to a workstation 20. The workstation 20 performs an electronic page make-up in accordance with the entered image data. In the electronic page make-up, there is created image data representative of an image for printing. This image data for printing represents an image consisting of pixels having gradations on the four colors of CMYK and the spot color. When the printing is performed, the image data for printing is converted into image data for plate making representative of a halftone dot image and then fed to a film printer 30. The film printer 30 creates printing film original plates for the four colors of CMYK and the spot color in accordance with the image data for plate making.

Machine plates are created from the printing film original plates and are mounted on a printing machine 40. Ink is applied to the machine plates mounted on the printing machine 40 and then transferred to a sheet for printing to form a printed image 41 on the sheet.

A series of works such that the film printer 30 is used to create the film original plates; the machine plates are created from the printing film original plates and are mounted on the printing machine 40; and ink is applied to the machine plates mounted on the printing machine 40 and then transferred to a sheet for printing to form the printed image 41 on the sheet, is very large scale work and it takes a lot of cost. For this reason, before performing the actual printing work, a personal computer 50 and a printer 60 which is used as a proofer, are used to create a proof image 61 in the manner as will be described as follows, and finish of the printed image 41 is confirmed beforehand.

When the proof image 61 is created, page description data described in page description language, which is created by the electronic page make-up on the workstation 20, is fed to the personal computer 50. The personal computer 50 converts the page description data into output image data suitable for the printer 60 which intends to output the proof image 61. The printer 60 receives the output image data and creates the proof image 61 in accordance with the output image data.

The printer 60 is a printer for creating a halftone dot image of process colors of four colors consisting of C, M, Y and K. The personal computer 50 receives the page description data from the workstation 20 shown in FIG. 1 via a connection cable. In the event that the workstation 20 is located apart from the personal computer 50, the personal computer 50 receives the page description data from the workstation 20 via the computer network, or alternatively through an MO disk (magneto-optical disk). While FIG. 1 shows the workstation 20 and the personal computer 50, which are separated from one another, it is acceptable that they are constructed in a united body, when it is permitted that they are established at the same place.

The personal computer 50 creates an output image data in accordance with the page description data thus received, so that the printer 60 creates a proof image in accordance with the output image data. Thus, confirmation of the proof image makes it possible to confirm finish of printing beforehand.

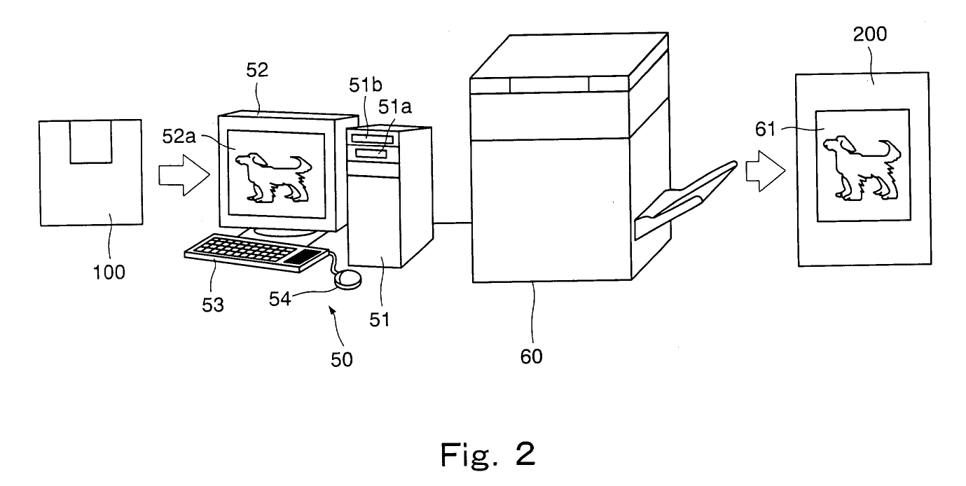

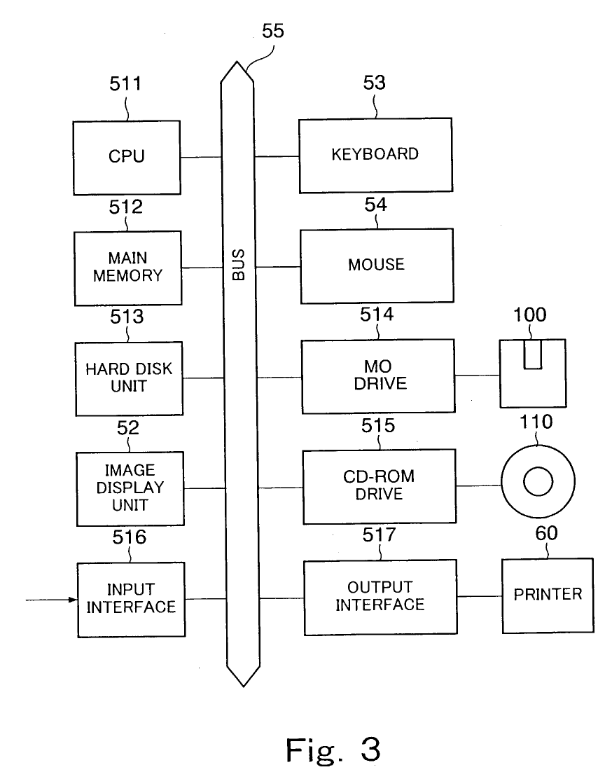

FIG. 2 is a perspective view of the personal computer 50 and the printer 60 shown in FIG. 1. FIG. 3 is a hardware structural view of the personal computer 50 shown in FIG. 1.

The personal computer 50 comprises, on an external appearance, as shown in FIG. 2, a main frame unit 51, an image display unit 52 for displaying an image on a display screen 52a in accordance with an instruction from the main frame unit 51, a keyboard 53 for inputting various sorts of information to the main frame unit 51 in accordance with a key operation, and a mouse 54 for inputting an instruction according to, for example, an icon and the like, through designation of an optional position in the display screen 52a, the icon and the like being displayed on the position on the display screen 52a. The main frame unit 51 has an MO mounting slot 51a for mounting an MO disk 100, and a CD-ROM mounting slot 51b for mounting a CD-ROM. The personal computer 50 serves as an image processing apparatus for implementing an image processing method according to an embodiment of the present invention.

The printer 60 is a printer for outputting of a proof image, and outputs a proof image 61 on a sheet 200 upon receipt of the output image data from the personal computer 50 in accordance with the instruction by the personal computer 50.

The main frame unit 51 comprises, as shown in FIG. 3, a CPU 511 for executing a various types of program, a main memory 512 in which a program stored in a hard disk unit 513 is read out and developed for executing by the CPU 511, the hard disk unit 513 for saving various types of programs and data, an MO drive 514 for accessing an MO disk 100 mounted thereon, a CD-ROM drive 515 for accessing a CD-ROM 110 mounted thereon, an input interface 516 connected to the workstation 20 (cf. FIG. 1), to receive image data from the workstation 20, and an output interface 517 to transmit image data to the printer 60. These various types of elements are connected via a bus 55 to the image display unit 52, the keyboard 53 and the mouse 54.

Aspects of the embodiment of the present invention reside in processing contents using the personal computer 50. And thus hereinafter there will be explained the processing contents using.

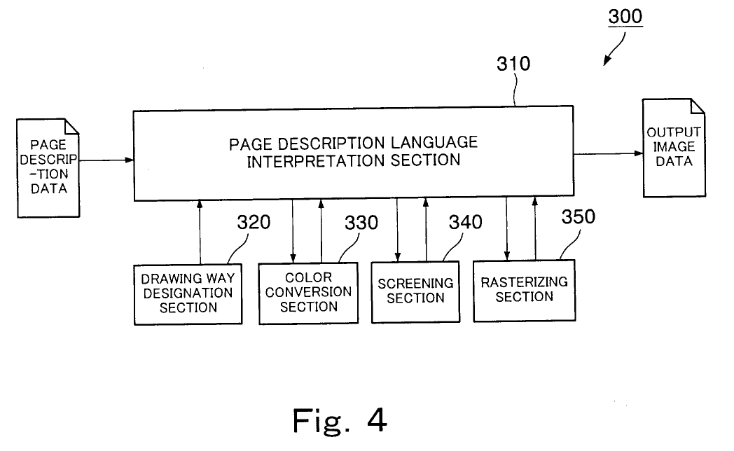

FIG. 4 is a functional block diagram of an image processing apparatus constructed in the personal computer 50 shown in FIG. 1.

An image processing apparatus 300 comprises a page description language interpretation section 310, a drawing way designation section 320, a color conversion section 330, a screening section 340, and a rasterizing section 350.

The image processing apparatus 300 is constructed in the personal computer 50 shown in FIG. 1 and FIG. 2. The image processing apparatus 300 receives page description data from the workstation 20 shown in FIG. 1 and converts the received page description data into output image data. The output image data is representative of a binary image which is subjected to screening. The output image data is fed to the printer 60 (cf. FIG. 1 and FIG. 2) to print out an output image on a sheet in accordance with the output image data.

Here, there will be explained the output image and the explanation of the image processing apparatus 300 will be made later.

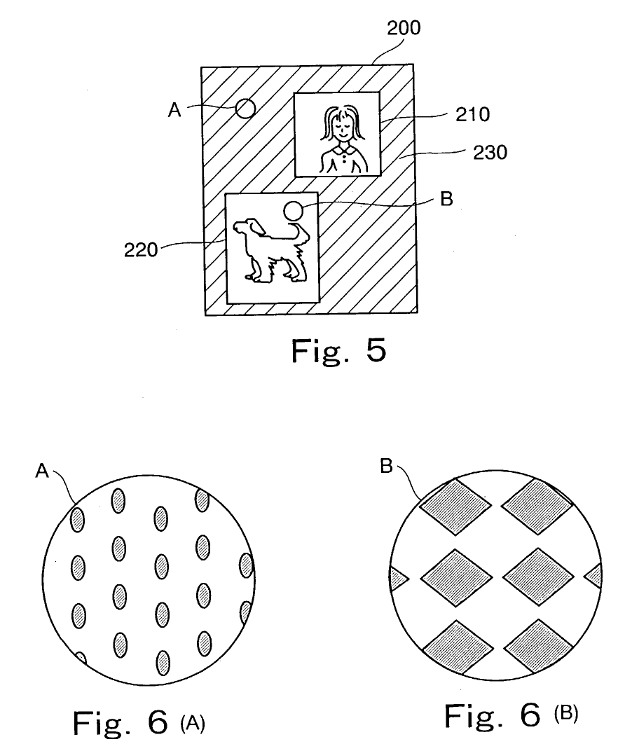

FIG. 5 is a view showing an example of the output image.

An output image shown in FIG. 5 is drawn on a sheet 200, and comprises two object drawing areas 210 and 220 (corresponding to an example of the first area referred to in the present invention) in which two objects are drawn, respectively, and a paper color area 230 (corresponding to an example of the second area referred to in the present invention) simulating a paper color of a sheet to be used in printing by the printing machine 40 (cf. FIG. 1), other than the two object drawing areas 210 and 220.

FIG. 6(A) and FIG. 6(B) are views showing enlarged internal images of circle A and circle B of the output image shown in FIG. 5, respectively.

FIG. 6(A) is an enlarged view of the inside of the circle A, which is a part of the paper color area 230 of the output image shown in FIG. 5. FIG. 6(B) is an enlarged view of the inside of the circle B, which is a part of the object drawing areas 210 and 220 of the output image shown in FIG. 5.

FIG. 6(A) is different from FIG. 6(B) in dot type (FIG. 6(A): oval dots, and FIG. 6(B): diamond-shaped dots), and in addition in the number of lines of dots (FIG. 6(A): for example 300 lpi, and FIG. 6(B): for example 120 lpi).

According to the present embodiment, in this manner, the object drawing areas 210 and 220 is different from the paper color area 230 in the dot type and the number of lines of dots as well. And thus the object drawing areas 210 and 220 is clearly distinguished from the paper color area 230 and thereby preventing those from being confused. Further, according to the present embodiment, the paper color area 230 is larger in the number of lines than the object drawing areas 210 and 220. Accordingly, the paper color area 230 is expressed with the feel of a material close to that of a printing sheet having uniform density.

Incidentally, according to the present embodiment, the object drawing areas 210 and 220 is different from the paper color area 230 in both the dot type and the number of lines of dots. However, even if they are different from one another in either one of the dot type and the number of lines of dots, it is possible to avoid the confusion of the object drawing areas 210 and 220 with the paper color area 230.

Further, according to the present embodiment, while the paper color area 230 of the output image shown in FIG. 5 is given with the number of lines of dots: for example 300 lpi, any one is acceptable, as the paper color area 230, which is larger in the number of lines of dots than the object drawing areas, and for example, 400 lpi is acceptable.

With respect to the dot type, according to the present embodiment, while there is raised, by way of example, a difference of geometry, it is possible, by way of another example, to utilize an FM screen from the paper color area 230, in the event that the object drawing areas 210 and 220 is concerned with an AM screen.

Now, returning to FIG. 4, the explanation of the image processing apparatus 300 shown in FIG. 4 will be continued.

The page description language interpretation section 310 of the image processing apparatus 300 interprets page description data having information representative of the same image as the output image as shown in FIG. 5 for instance, fed from the workstation 20 (cf. FIG. 1). And in accordance with the interpretation, the page description language interpretation section 310 causes: the color conversion section 330 to perform a color conversion so that the same color as an image obtained through printing by the printing machine 40 (cf. FIG. 1) is reproduced when the printer 60 (cf. FIG. 1 and FIG. 2) outputs the proof image; the screening section 340 to perform a screening processing; and the rasterizing section 350 to perform a rasterizing processing (processing for creating raster data), and whereby output image data is created.

Here, the drawing way designation section 320 designates a drawing way, which comprises the dot type and the number of lines of dots, in accordance with an operation by an operator or a file created beforehand. The drawing way for the dot type and the number of lines of dots is able to be individually designated for the whole area of a printing paper representative of a color of the background of the printing paper, and objects to be represented on the whole area of the printing paper on an overlapping basis. Here, the drawing way is designated for each of those items. When an object is superposed on the printing paper representative of a color of the background of the printing paper, the object is effective with respect to the overlapped area, and the representation of the color of the background of the printing paper is cancelled with respect to the overlapped area. This is the same also in the event that another object is superposed on one object. That is, the superposing object appears on the output image.

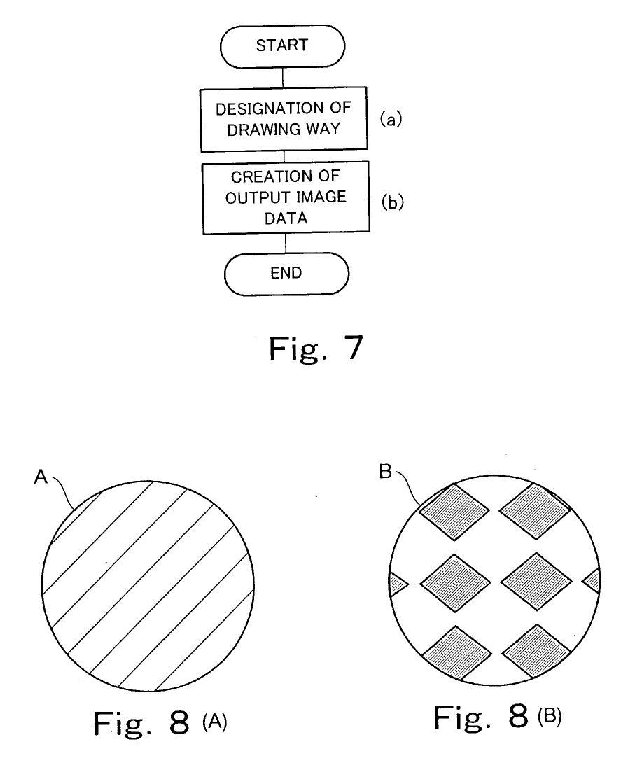

FIG. 7 is a flowchart useful for understanding an embodiment of an image processing method according to the present invention, which is implemented using the image processing apparatus 300 shown in FIG. 4.

A step (a) of FIG. 7 is of a drawing way designation using the drawing way designation section 320 of FIG. 4.

Here, the drawing way designation section 320 of FIG. 4 designates drawing ways for the dot type and the number of lines of dots with respect to the whole area of a printing paper representative of a color of the background of the printing paper, and the objects to be represented on the whole area of the printing paper.

At that time, with respect to at least either one of the dot type and the number of lines of dots, mutually different dot types or mutually different numbers of lines of dots are designated for the whole area of a printing paper representative of a color of the background of the printing paper, and the respective object. By way of example, according to the example shown in FIG. 5, both the dot type and the number of lines of dots are different between the whole area of a printing paper representative of a color of the background of the printing paper, and the respective object. Between the object and the object, it is either acceptable that the dot type and the number of lines of dots are different, or they are identical. Usually, the dot type and the number of lines of dots are identical. According to the example shown in FIG. 5, the two objects are drawn with the same dot type and the same number of lines of dots.

A step (b) of FIG. 7 is of an output image data creation.

The page description language interpretation section 310 in FIG. 4 interprets the received page description data and causes the screening section 340 to perform a screening processing in accordance with the drawing way (the dot type and the number of lines of dots) designated by the drawing way designation section 320. Thus, as explained referring to FIG. 5 and FIG. 6(A) and FIG. 6(B), there are generated output image data representative of an output image different in the dot type and the number of lines of dots between the paper color area 230 representative of a color of the background of the printing paper and the object drawing areas 210 and 220 drawing the objects.

FIG. 8(A) and FIG. 8(B) are views showing partially enlarged portions of the output image according to another embodiment.

Here, there is dealing with an output image printed out by a printer capable of representing gradation by both the density and the halftone dot, but different from the printer 60 shown in FIG. 1 and FIG. 2. This output image is the same as the output image shown in FIG. 5. Accordingly, the explanation will be made referring to FIG. 5. Here, however, it is assumed that the output image is outputted by a printer capable of representing gradation by both the density and the halftone dot, as mentioned above.

FIG. 8(A) is an enlarged view of the inside of the circle A, which is a part of the paper color area 230 of the output image shown in FIG. 5. FIG. 8(B) is an enlarged view of the inside of the circle B, which is a part of the object drawing areas 210 and 220 of the output image shown in FIG. B.

FIG. 8(B) is the same as FIG. 6(B). With respect to the object drawing areas 210 and 220, in a similar fashion to that of the above-mentioned embodiment, those areas are expressed by the designated dot line and the designated dot type of dots.

FIG. 8(A) denotes that the area is expressed by the even density, but not the halftone dots. According to the present embodiment, the simulation of the paper color of the printing paper is expressed by the continuous gradation (density gradation).

According to the present embodiment, there is needed a special printer capable of outputting a print image representative of gradation with both the density and the halftone dots. Preparation of such a printer makes it possible to obtain a proof image in which the paper color expression is closer to the printing image than the above-mentioned embodiment (cf. FIG. 6).

Now, there will be explained image processing apparatus and image processing method of creating output image data suitable for a printer capable of expressing gradation with both the density and the halftone dots, referring to FIG. 4 and FIG. 7, again.

In this case, in the step (a) of FIG. 7, the drawing way designation section 320 of FIG. 7 is used, as to the area of the background throughout the whole of a sheet, to designate that a paper color of the printing paper is to be reproduced by the density gradation expression, and as to the objects, to designate dot type and the number of lines of dots. Further, in the step of the output image data creation of the step (b) in FIG. 5, the page description language interpretation section 310 in FIG. 4 is operated to activate the color conversion section 330, the screening section 340, and the rasterizing section 350, so that the color conversion processing, the screening processing, and the rasterizing processing are carried out, respectively. Of those processing, the screening processing using the screening section 340 creates data expressed by density (that is, 100% in form of dot) instead of screening as to the expression of the color of the background of the paper, and in addition density according to the paper color. That is, in case of the image processing apparatus according to the present embodiment, as compared with the image processing apparatus according to the previous embodiment in which the color of the background of the paper is also expressed by halftone dots, it is possible to perform a processing in which not only the screening data, but also the data by the density gradation expression is mixed.

In this manner, there is created output image data representative of the output image of FIG. 5 according to the present embodiment, that is, the output image outputted by a printer capable of representing gradation with both the density and the halftone dots. This output image data is fed to the printer capable of representing gradation with both the density and the halftone dots, so that the printer prints out the output image of FIG. 5 according to the present embodiment.

In any of the embodiments, while the output image data is fed to a printer to print out an output image, there is no need to always feed the output image data to a printer. It is acceptable to feed an image display unit such as a CRT display and a liquid crystal display, so that an output image, which is represented by halftone dots on the object drawing area, or is represented by halftone dots different from those of the object drawing area on the color of the background of the sheet, alternatively by density on the color of the background of the sheet, is displayed on a display screen of the image display unit.

As mentioned above, according to the present invention, it is possible to created output image data representative of an output image capable of avoiding a confusion between an area on which a color of the background of a printing sheet is simulated, and an area on which an object to be printed on the sheet is drawn, so that the output image capable of avoiding such a confusion can be obtained in accordance with the output image data.

While the present invention has been described with reference to the particular illustrative embodiments, it is not to be restricted by those embodiments but only by the appended claims. It is to be appreciated that those skilled in the art can change or modify the embodiments without departing from the scope and sprit of the present invention.

What is claimed is:

1. An image processing method of converting page data in which one or a plurality of objects is described in a page description language into output image data representative of an output image, said image processing method comprising steps of:
designating a drawing way for a first area on which an object is drawn, on a drawing area on which an output image is drawn, and a drawing way for a second area excepting the first area, on the drawing area, the drawing way for the first area being different from the drawing way for the second area; and
creating output image data drawn in accordance with the mutually different drawing ways in which the first area and the second area are designated, respectively.

2. An image processing method according to claim 1, wherein as the drawing way for the first area and the drawing way for the second area, drawing ways using halftone dots of mutually different dot types are designated.

3. An image processing method according to claim 1, wherein as the drawing way for the first area and the drawing way for the second area, drawing ways using halftone dots of mutually different number of lines are designated.

4. An image processing method according to claim 2, wherein as the drawing way for the first area and the drawing way for the second area, drawing ways using halftone dots of mutually different number of lines are designated.

5. An image processing method according to claim 1, wherein as the drawing way for the first area, a drawing way using halftone dots is designated, and as the drawing way for the second area, a drawing way in which gradation is expressed by density is designated.

6. An output image including one or a plurality of objects outputted on a sheet, wherein a first area in which the object is drawn and a second area expressing a color of a background, excepting the first area, are drawn by mutually different drawing ways.
